(19) United States
(12) Patent Application Publication
(10) Pub. No.: US 2004/0265144 A1
(43) Pub. Date: Dec. 30, 2004

(54) Hybrid compressor

(76) Inventors: Tetsuhiko Fukanuma, Kariya-shi (JP); Masahiro Kawaguchi, Kariya-shi (JP); Yasuharu Odachi, Kariya-shi (JP); Yoichi Takashima, Kariya-shi (JP); Hiroyuki Nakaima, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/830,186

(22) Filed: Apr. 22, 2004

(30) Foreign Application Priority Data
Apr. 25, 2003 (JP) 2003-122971

(51) Int. Cl. H02K 1/22; F04B 1/12; F04B 27/08

(52) U.S. Cl. 417/374; 417/269; 417/316

(57) ABSTRACT

In a hybrid compressor, a compression mechanism includes a rotary shaft, which has a first end and a second end. The first end of the rotary shaft is coupled to a rotating body, which receives power from an external drive source. The second end of the rotary shaft is coupled to an electric motor, which drives the rotary shaft. The rotary shaft is coupled to a rotor of the electric motor via a one-way clutch, which prevents power from being transmitted from the rotary shaft to the rotor. The rotor is supported by a motor shaft, which is separate from the rotary shaft. The second end of the rotary shaft is coupled to an end of the motor shaft using the one-way clutch as a coupling.

### BACKGROUND OF THE INVENTION

The present invention relates to a hybrid compressor used in a refrigerant cycle constituting part of a vehicle air conditioner. More specifically, the present invention pertains to a hybrid compressor that has a compression mechanism driven by a vehicle engine and an electric motor.

A typical hybrid compressor includes a compression mechanism that is driven by an engine and an electric motor. Specifically, the compression mechanism has a rotary shaft having a first end and a second end. The first end of the rotary shaft is coupled to a rotating body, which receives power of the engine. The second end of the rotary shaft is coupled to the electric motor, which rotates the rotary shaft. For example, Japanese Laid-Open Patent Publication No. 2000-130323 discloses such a hybrid compressor.

In the prior art, however, the rotary shaft extends from the compression mechanism to support a rotor of the electric motor at the second end. Thus, the rotary shaft is long and heavy. Therefore, when the compression mechanism is driven by the engine, the rotor is unnecessarily rotated with the compression mechanism. Accordingly, the load torque applied to the hybrid compressor (or the torque required to drive the hybrid compressor) is increased, thereby increasing the load on the engine.

In the prior art, the rotor of the electric motor is directly supported by the rotary shaft of the compression mechanism. In other words, the compression mechanism and the electric motor share the rotary shaft. Therefore, a process for mounting components of the compression mechanism to the rotary shaft and a process for mounting components of the electric motor to the rotary shaft cannot be performed on different manufacturing lines in parallel. Therefore, the manufacturing efficiency of the hybrid compressor is reduced.

### SUMMARY OF THE INVENTION

Accordingly, it is an objective of the present invention to provide a hybrid compressor that reduces the load on an external drive source when a compression mechanism is driven by the external drive source, and improves the manufacturing efficiency.

To achieve the above objective, the present invention provides a hybrid compressor provided with a compression mechanism having a rotary shaft, and an electric motor having a rotor. The rotary shaft of the compression mechanism has a first end and a second end. The first end of the rotary shaft is coupled to a rotating body for receiving power from an external drive source. The second end of the rotary shaft is coupled to the electric motor for receiving power from the electric motor. The hybrid compressor further includes a motor shaft and a one-way clutch. The motor shaft is located in the electric motor. The motor shaft supports the rotor and is separate from the rotary shaft. The a one-way clutch is located between the second end of the rotary shaft and the motor shaft. The one-way clutch couples the rotary shaft to the motor shaft and is capable of preventing power from being transmitted from the rotary shaft to the rotor. The one-way clutch is used as a coupling between the rotary shaft and the motor shaft.

The present invention also provides a method for assembling a hybrid compressor. A rotary shaft of a compression mechanism has a first end and a second end. The first end is coupled to a rotating body for receiving power from an external drive source. The second end is coupled to an electric motor for receiving power from the electric motor. The method includes assembling a motor shaft to which a rotor and a one-way clutch are mounted in advance to the rotary shaft along the axial direction. In the same process as assembling the motor, the motor shaft is coupled to the rotary shaft using the one-way clutch as a coupling.

According to the present invention, when a compression mechanism is driven by an external drive source, a motor shaft and a rotor of an electric motor do not rotate with a rotary shaft. Therefore, the load applied to the external drive source is reduced. Since the rotary shaft is separate from the motor shaft, a process for mounting components of the compression mechanism to the rotary shaft and a process for mounting components of the electric motor to the motor shaft are performed in separate manufacturing lines in parallel. This improves the manufacturing efficiency of the hybrid compressor.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWINGS

The invention, together with objects and advantages thereof, may best be understood by reference to the following description of the presently preferred embodiments together with the accompanying drawings in which:

FIG. 1 is a schematic cross-sectional view illustrating a hybrid compressor;

FIG. 2 is a cross-sectional view illustrating a state before an electric motor is mounted to a housing;

FIG. 3(a) is an enlarged cross-sectional view illustrating a one-way clutch;

FIG. 3(b) is an enlarged cross-sectional view illustrating a one-way clutch; and

FIG. 4 is a cross-sectional view illustrating a hybrid compressor according to a modified embodiment.

### DETAILED DESCRIPTION OF THE PREFERRED EMBODIMENTS

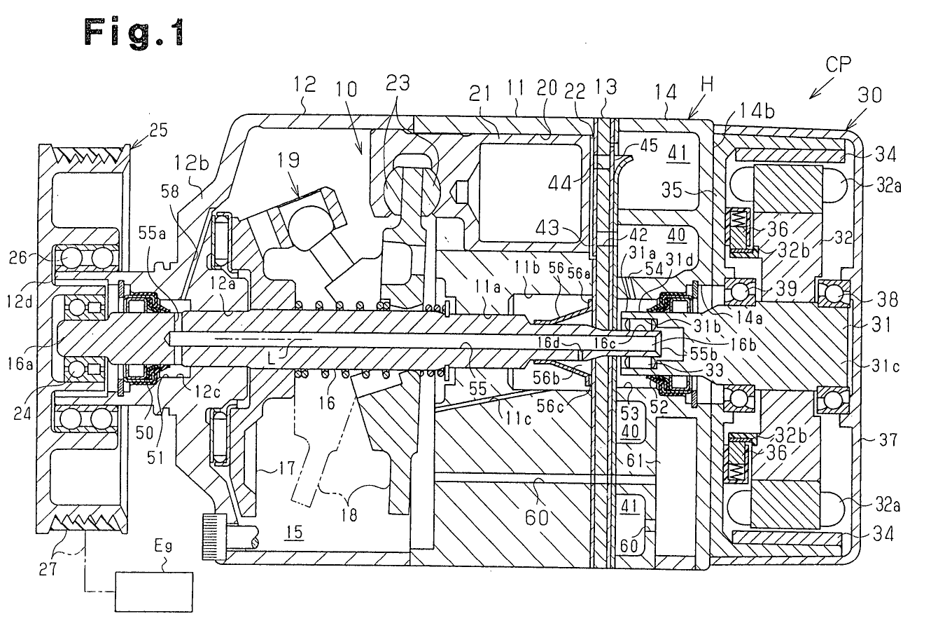

A hybrid compressor CP according to a first embodiment of the present invention will now be described with reference to FIGS. 1 to 3. The hybrid compressor CP is used in a refrigerant cycle constituting part of a vehicle air conditioner. The left end of the hybrid compressor in FIG. 1 is defined as the front of the hybrid compressor, and the right end is defined as the rear of the hybrid compressor.

As shown in FIG. 1, the hybrid compressor (hereinafter, simply referred to as a compressor) CP includes a piston type compression mechanism (hereinafter, simply referred to as a compression mechanism) 10, a rotating body that receives power from a vehicle engine Eg, and an electric motor 30. The rotating body is a pulley 25 in this embodiment.

The compression mechanism 10 is accommodated in a housing H. The housing H includes a cylinder block 11, a front housing member 12, which is secured to the front end of the cylinder block 11, and a rear housing member 14, which is secured to the rear end of the cylinder block 11. A valve plate assembly 13 is located between the cylinder block 11 and the rear housing member 14.

A crank chamber 15 is defined by the cylinder block 11 and the front housing member 12. A rotary shaft 16 extends through the crank chamber 15 and is rotatably supported by the cylinder block 11 and the front housing member 12. The rotary shaft 16 is supported by slide bearing portions 11a, 12a in the cylinder block 11 and the front housing member 12. A lug plate 17 is secured to the rotary shaft 16 in the crank chamber 15 and rotates integrally with the rotary shaft 16.

The crank chamber 15 accommodates a cam plate, which is a swash plate 18. The swash plate 18 is supported by the rotary shaft 16 to slide along and tilt with respect to the rotary shaft 16. A hinge mechanism 19 is located between the lug plate 17 and the swash plate 18. Therefore, the hinge mechanism 19 permits the swash plate 18 to rotate integrally with the lug plate 17 and the rotary shaft 16. The swash plate 18 slides along the rotary shaft 16 in the direction of an axis L of the rotary shaft 16 and tilts with respect to the rotary shaft 16.

A plurality of cylinder bores 20 (only one is shown in FIG. 1) are formed in the cylinder block 11 around the rotary shaft 16. A single headed piston 21 is accommodated in each cylinder bore 20. Each piston 21 and the corresponding cylinder bore 20 define a compression chamber 22, the volume of which is changed according to reciprocation of the piston 21. Each piston 21 is engaged with the periphery of the swash plate 18 via a pair of shoes 23. Therefore, when the swash plate 18 rotates integrally with the rotary shaft 16, rotation of the swash plate 18 is converted to reciprocation of each piston 21. In this embodiment, the lug plate 17, the swash plate 18, and the hinge mechanism 19 constitute a crank portion for converting rotation of the rotary shaft 16 to reciprocation of each piston 21. The crank portion constitutes the compression mechanism 10 with the pistons 21 and the shoes 23.

The valve plate assembly 13 and the rear housing member 14 define an annular suction chamber 40 and an annular discharge chamber 41. A through hole 14a is formed at the center of the rear housing member 14. The through hole 14a extends in the axial direction of the rear housing member 14. The suction chamber 40 is formed to surround the through hole 14a, and the discharge chamber 41 is formed to surround the suction chamber 40.

The suction chamber 40 is connected to the discharge chamber 41 via an external refrigerant circuit (not shown), which constitutes part of the refrigerant cycle. When each piston 21 moves from the top dead center position to the bottom dead center position, refrigerant gas in the suction chamber 40 is drawn into the corresponding compression chamber 22 via corresponding one of suction ports 42 and suction valves 43 formed in the valve plate assembly 13. When each piston 21 moves from the bottom dead center position to the top dead center position, the refrigerant gas in the compression chamber 22 is compressed to a predetermined pressure and is discharged to the discharge chamber 41 via corresponding one of discharge ports 44 and discharge valves 45 formed in the valve plate assembly 13.

The inclination angle of the swash plate 18 is adjusted by changing the balance between the pressure in the compression chamber 22 and the pressure in the crank chamber 15 (crank pressure) that acts on each piston 21. In this embodiment, the inclination angle of the swash plate 18 is adjusted by positively changing the crank pressure.

The housing H includes a supply passage 60 and a control valve 61. The supply passage 60 connects the discharge chamber 41 to the crank chamber 15. The control valve 61 is located in the supply passage 60. Adjusting the opening degree of the control valve 61 controls the flow rate of highly pressurized refrigerant gas supplied from the discharge chamber 41 to the crank chamber 15 through the supply passage 60. This determines the crank pressure. The inclination angle of the swash plate 18 changes in accordance with the change in the crank pressure. Accordingly, the stroke of each piston 21, or the displacement of the compressor CP is adjusted. The crank portion of the preferred embodiment has a variable displacement structure that controls the displacement by adjusting the flow rate of refrigerant gas delivered to the crank chamber.

When the opening degree of the control valve 61 is decreased to lower the crank pressure, the inclination angle of the swash plate 18 is increased. Accordingly, the displacement of the compressor CP is increased. Contrary, when the opening degree of the control valve 61 is increased to increase the crank pressure, the inclination angle of the swash plate 18 is decreased. Accordingly, the displacement of the compressor CP is decreased.

A first end of the rotary shaft 16, which is a front end 16a in this embodiment, projects outside the housing H via a through hole 12c formed in a front wall 12b of the front housing member 12. The front end 16a of the rotary shaft 16 is coupled to the pulley 25 via a first one-way clutch 24 outside the housing H. With regard to one direction of rotation, the first one-way clutch 24 permits power transmission from the pulley 25 to the rotary shaft 16 and prevents power from being transmitted from the rotary shaft 16 to the pulley 25.

A support cylinder 12d is formed at the front wall 12b of the front housing member 12 and projects forward. The pulley 25 is rotatably supported by the support cylinder 12d with a radial bearing 26. The pulley 25 is connected to and driven by the engine Eg via a belt 27.

A second end of the rotary shaft 16, which is a rear end 16b in this embodiment, is located in the through hole 14a of the rear housing member 14. The rear end 16b of the rotary shaft 16 is connected to and driven by the electric motor 30.

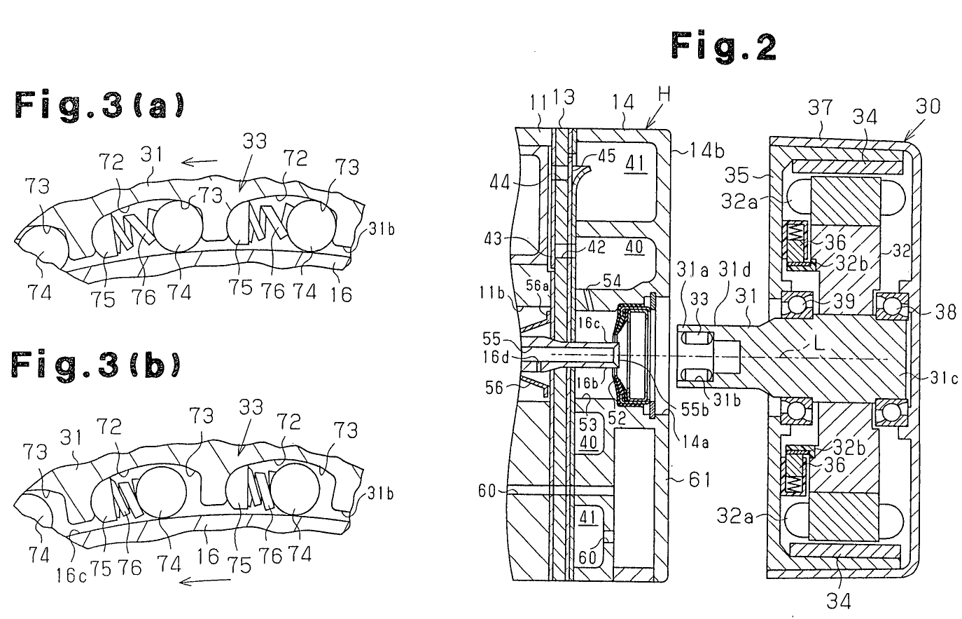

The electric motor 30 includes a brush DC motor and forms a unit. That is, as shown in FIGS. 1 and 2, the electric motor 30 includes a motor case 37, which has an open front end, and a support member 35, which is fixed to the motor case 37. The motor case 37 and the support member 35 form a motor housing. The motor case 37 and the support member 35 rotatably support a motor shaft 31 via angular bearings 38, 39. The angular bearing 38 supports a rear end 31c of the motor shaft 31 and the angular bearing 39 supports a front end 31a of the motor shaft 31, which faces the rotary shaft 16. The front end 31a of the motor shaft 31 projects forward from the motor case 37.

A rotor 32 is secured to the outer circumferential surface of the motor shaft 31 inside the motor case 37. The rotor 32 is provided with a coil 32a and a commutator 32b. A stator (permanent magnet) 34 is secured to the inner circumferential surface of the motor case 37 via the support member 35. The stator 34 surrounds the outer circumference of the rotor 32.

Brush assemblies 36 are attached to the support member 35 and slide against the commutator 32b. The rotor 32 of the electric motor 30 is rotated by power supply to the coil 32a via the brush assemblies 36. Power is supplied to the brush assemblies 36 from an external power source via a drive circuit (not shown) secured to the housing H.

In this embodiment, the electric motor 30, which is formed as a unit, is attached to the rear of the housing H in the direction of the axis L such that the rotary shaft 16 of the compression mechanism 10 is connected to and driven by the electric motor 30. The electric motor 30 is attached to a rear face 14b of the rear housing member 14, or the housing H, such that the motor shaft 31 is located at the rear of the rotary shaft 16 and coaxial with the rotary shaft 16.

In this state, the front end 31a of the motor shaft 31 is inserted in the through hole 14a of the rear housing member 14. The front end 31a of the motor 31 has a cylindrical shape and has an inner circumferential surface 31b for surrounding an outer circumferential surface 16c of the rear end 16b of the rotary shaft 16. A second one-way clutch 33 is located in a space between the outer circumferential surface 16c of the rotary shaft 16 and the inner circumferential surface 31b of the motor shaft 31. The rotary shaft 16 is coupled to the motor shaft 31 via the second one-way clutch 33 used as a coupling. The second one-way clutch 33 couples the rotary shaft 16 to the motor shaft 31.

In this embodiment, since the motor shaft 31 of the electric motor 30, which is formed as a unit in advanced, is attached to the rotary shaft 16 in the direction of the axis L, the inner circumferential surface 31b of the motor shaft 31 is coupled to the outer circumferential surface 16c of the rotary shaft 16 viah the second one-way clutch 33 at the same time. The second one-way clutch 33 permits power transmission from the motor shaft 31 to the rotary shaft 16 and prevents power from being transmitted from the rotary shaft 16 to the motor shaft 31.

As shown in FIGS. 3(a) and 3(b), accommodating recesses 72 are formed in the inner circumferential surface 31b of the motor shaft 31 about the axis L. The accommodating recesses 72 are spaced from each other at predetermined intervals. A power transmission surface 73 is formed at a trailing end of each accommodating recess 72. Each accommodating recess 72 accommodates a roller 74 arranged parallel to the axis L. The roller 74 is movable between an engaged position where the roller 74 is engaged with the power transmission surface 73 (the position of the roller 74 shown in FIG. 3(a)) and a disengaged position where the roller 74 is apart from the power transmission surface 73 (the position of the roller 74 shown in FIG. 3(b)).

A spring seat 75 is formed at a leading end of each accommodating recess 72 opposite to the power transmission surface 73. A spring 76 is located between each spring seat 75 and the corresponding roller 74 to urge the roller 74 towards the engaged position.

As shown in FIG. 3(a), when the motor shaft 31 is rotated in the direction shown by an arrow, each spring 76 urges the corresponding roller 74 towards the engaged position where the roller 74 is engaged with the corresponding power transmission surface 73. In this state, the friction between each power transmission surface 73 and the corresponding roller 74 and the friction between the rollers 74 and the outer circumferential surface 16c of the rotary shaft 16 cause the rotary shaft 16 to rotate with the motor shaft 31 in the same direction.

As shown in FIG. 3(b), if, for example, the rotary shaft 16 is rotated in the direction of an arrow when the motor shaft 31 is stopped, each roller 74 separates from the engaged position against the force of the spring 76. In this case, the rotary shaft 16 runs idle with respect to the motor shaft 31.

In this embodiment, when the rotary shaft 16 is rotated by the engine Eg, power supply to the electric motor 30 is stopped. In this state, the second one-way clutch 33 prevents power from being transmitted from the rotary shaft 16 to the motor shaft 31. This prevents energy loss from being caused by the rotation of the rotor 32. When the rotary shaft 16 is rotated by the electric motor 30, the first one-way clutch 24 prevents power from being transmitted from the rotary shaft 16 to the pulley 25. Accordingly, power of the electric motor 30 is not transmitted to the engine Eg unnecessarily.

A front sealing member 50 is accommodated in the through hole 12c formed in the front wall 12b of the front housing member 12 to seal a space between the outer circumferential surface of the front end 16a of the rotary shaft 16 and the inner circumferential surface of the through hole 12c. That is, the front sealing member 50 seals the inside of the housing H from the outside of the housing H. The front sealing member 50 is a lip seal. A front lubrication chamber 51 is defined at the front half of the through hole 12c. The front lubrication chamber 51 is located forward of the slide bearing portion 12a in the through hole 12c. The front lubrication chamber 51 is connected to the crank chamber 15 via a communication passage 58 formed in the front wall 12b.

A rear sealing member 52 is accommodated in the through hole 14a of the rear housing member 14 to seal a space between an outer circumferential surface 31d of the front end 31a of the motor shaft 31 and the inner circumferential surface of the through hole 14a. That is, the rear sealing member 52 seals the inside of the housing H from the outside of the housing H. The rear sealing member 52 is a lip seal. A rear lubrication chamber 53 is defined at the front half of the through hole 14a. The rear lubrication chamber 53 is located rearward of the valve plate assembly 13 in the through hole 14a. The space between the outer circumferential surface 16c of the rotary shaft 16 and the inner circumferential surface 31b of the motor shaft 31 and the second one-way clutch 33 are located inside the rear lubrication chamber 53.

The rear lubrication chamber 53 is formed separately from the suction chamber 40 but is connected to the suction chamber 40 via a restriction passage 54. The restriction passage 54 is formed in a partition, which defines the suction chamber 40 and the rear lubrication chamber 53.

The front and rear lubrication chambers 51, 53 are connected to each other via an axial passage 55 formed in the rotary shaft 16 along the axis L. An inlet 55a of the axial passage 55 is formed in the outer circumferential surface of the rotary shaft 16. The inlet 55a is located in the vicinity of the contact portion between the front sealing member 50 and the front lubrication chamber 51 of the front housing member 12. An outlet 55b of the axial passage 55 is formed in the rear end face of the rotary shaft 16 and is located in the rear lubrication chamber 53 of the rear housing member 14. The outlet 55b is open to the space in the inner circumferential surface 31b of the motor shaft 31. That is, the outlet 55b of the axial passage 55 is connected to the space between the outer circumferential surface 16c of the rotary shaft 16 and the inner circumferential surface 31b of the motor shaft 31.

In this embodiment, the communication passage 58, the front lubrication chamber 51, the axial passage 55, the space between the outer circumferential surface 16c of the rotary shaft 16 and the inner circumferential surface 31b of the motor shaft 31, the rear lubrication chamber 53, and the restriction passage 54 form a refrigerant passage. The refrigerant passage adjusts the crank pressure in controlling the displacement of the compressor. That is, the crank pressure is determined by controlling the balance between the amount of highly pressurized refrigerant gas supplied from the discharge chamber 41 to the crank chamber 15 via the supply passage 60 and the amount of refrigerant gas sent from the crank chamber 15 to the suction chamber 40 through the refrigerant passage. The refrigerant gas that flows through the refrigerant passage from the crank chamber 15 to the suction chamber 40 cools the front and rear sealing members 50, 52 and the second one-way clutch 33. The lubricant included in the refrigerant gas lubricates the front and rear sealing members 50, 52 and the second one-way clutch 33.

A shaft bore 11b is formed at the rear of the slide bearing portion 11a in the cylinder block 11. A restrictor 56 is accommodated in the shaft bore 11b. The restrictor 56 is shaped like a funnel and has a wide circular rear end that tapers to a narrow front end. The front end of the restrictor 56 having a small diameter is fitted to the outer circumferential surface of the rotary shaft 16. A flange 56a is formed at the rear end of the restrictor 56. The flange 56a selectively abuts against the front surface of the valve plate assembly 13. A space 56b defined by the inner circumferential surface of the restrictor 56, the outer circumferential surface of the rotary shaft 16, and the front surface of the valve plate assembly 13 is connected to the axial passage 55 via a communication hole 16d formed in the rotary shaft 16. The shaft bore 11b is connected to the crank chamber 15 via an oil return passage 11c formed in the cylinder block 11. The rearward movement of the rotary shaft 16 is restricted by the abutment of the flange 56a of the restrictor 56 against the front surface of the valve plate assembly 13.

Some of the lubricant on the inner circumferential surface of the axial passage 55 is introduced into the space 56b of the restrictor 56 via the communication hole 16d by the centrifugal force generated by the rotation of the rotary shaft 16. The lubricant in the space 56b of the restrictor 56 is then discharged outside the space 56b via a lead-out passage 56c formed in the flange 56a and introduced to the shaft bore 11b. When the restrictor 56 is rotated integrally with the rotary shaft 16, the pressure in the shaft bore 11b is increased. When the pressure in the shaft bore 11b becomes greater than the pressure in the crank chamber 15, the lubricant in the shaft bore 11b is returned to the crank chamber 15 through the oil return passage 11c.

The preferred embodiment provides the following advantages.

(1) The rotary shaft 16 of the compression mechanism 10 is coupled to the rotor 32 of the electric motor 30 via the second one-way clutch 33. The rotor 32 is supported by the motor shaft 31, which is separate from the rotary shaft 16. The rear end 16b of the rotary shaft 16 is coupled to the front end 31a of the motor shaft 31 via the second one-way clutch 33. Accordingly, when the compression mechanism 10 is driven by the engine Eg, the motor shaft 31 and the rotor 32 of the electric motor 30 do not rotate with the rotary shaft 16. Therefore, the load applied to the engine Eg is reduced. Since the rotary shaft 16 is separate from the motor shaft 31, a process for mounting components of the compression mechanism 10 to the rotary shaft 16 and a process for mounting components of the electric motor 30 to the motor shaft 31 are performed in separate manufacturing lines in parallel. This improves the manufacturing efficiency of the compressor CP.

(2) The front end 31a of the motor shaft 31 has a cylindrical shape and has the inner circumferential surface 31b. The inner circumferential surface 31b surrounds the outer circumferential surface 16c of the rear end 16b of the rotary shaft 16. The second one-way clutch 33 is located in a space between the outer circumferential surface 16c and the inner circumferential surface 31b. Therefore, the second one-way clutch 33 is located along the radial direction of the rotary shaft 16 and the motor shaft 31. Thus, for example, as compared to a case where the end of a rotary shaft axially faces the end of a motor shaft and a one-way clutch is located between the opposing ends, the size of the compressor CP is easily reduced in the axial direction.

In the structure where the rear sealing member 52 contacts the outer circumferential surface 31d of the motor shaft 31 as in the preferred embodiment, the second one-way clutch 33 is located radially inward of the rear sealing member 52. That is, for example, contrary to a case where a one-way clutch is located between the front end of the motor shaft 31 and the rear end of the rotary shaft 16, the second one-way clutch 33 need not be located forward of the rear sealing member 52. In this case, for example, the size of the rear lubrication chamber 53, which accommodates the second one-way clutch 33, is easily reduced in the axial direction.

(3) The rear end 31c of the motor shaft 31 projects outside the housing H. The rear sealing member 52 is located in the housing H to seal the motor shaft 31. The rear sealing member 52 permits the second one-way clutch 33 to be located in the housing H. Therefore, the second one-way clutch 33 is easily lubricated using lubricant for lubricating the compression mechanism 10 in the housing H.

(4) The second one-way clutch 33 is located in the refrigerant passage, which connects the crank chamber 15 to the suction chamber 40. Therefore, the second one-way clutch 33 is effectively lubricated and cooled by refrigerant gas that flows from the crank chamber 15 to the suction chamber 40. Furthermore, the refrigerant passage is used for controlling the pressure in the crank chamber 15. Therefore, the second one-way clutch 33 and the front and rear sealing members 50, 52 are cooled and lubricated by refrigerant gas flow that is positively formed in the refrigerant passage for adjusting the pressure in the crank chamber 15.

(5) The refrigerant passage, which connects the crank chamber 15 to the suction chamber 40, is constituted by the axial passage 55 in the rotary shaft 16 and a space between the outer circumferential surface 16c of the rotary shaft 16 and the inner circumferential surface 31b of the motor shaft 31 connected to the axial passage 55. The second one-way clutch 33 is located in the space. Therefore, the refrigerant gas supplied from the crank chamber 15 to the suction chamber 40 via the refrigerant passage flows through the space. Thus, the second one-way clutch 33 is lubricated and cooled in a suitable manner.

It should be apparent to those skilled in the art that the present invention may be embodied in many other specific forms without departing from the spirit or scope of the invention. Particularly, it should be understood that the invention may be embodied in the following forms.

In the preferred embodiment, by mounting the electric motor 30, which is formed as a unit, to the rear housing member 14, which forms part of the housing H, the rotary shaft 16 of the compression mechanism 10 is coupled connected to the motor shaft 31. However, the assembling process of the compressor CP is not limited to this. For example, the rear housing member 14, which forms part of the housing H, may be attached to the electric motor 30 in advance. The assembly of the rear housing member 14 and the electric motor 30 may be secured to the cylinder block 11 via the valve plate assembly 13 such that the rotary shaft 16 is coupled to the motor shaft 31.

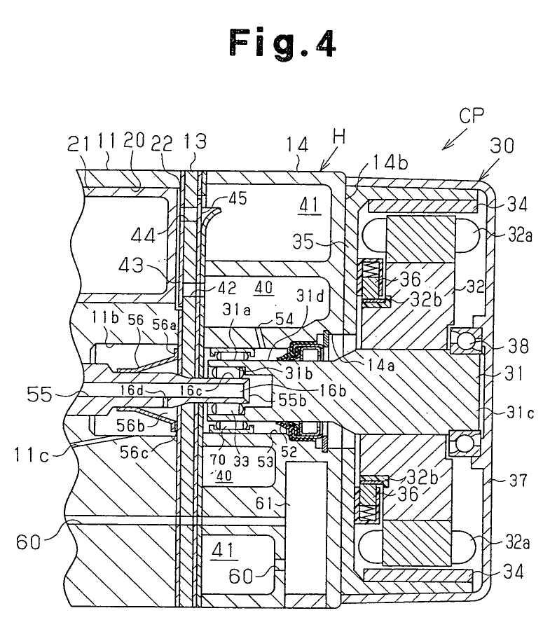

In the preferred embodiment, the angular bearing 39, which supports a portion including the front end 31a of the motor shaft 31, is located outside the housing H, that is, at the rear of the rear sealing member 52. However, the angular bearing 39 may be located at a position frontward of the rear sealing member 52 inside the housing H as shown in FIG. 4. In this case, the rear lubrication chamber 53 accommodates a bearing 70, which rotatably supports the front end 31a of the motor shaft 31 in the housing H (rear housing member 14). The bearing 70 is located between the outer circumferential surface 31d of the front end 31a of the motor shaft 31 and the inner circumferential surface of the rear lubrication chamber 53, which surrounds the outer circumferential surface 31d. Accordingly, the bearing 70 is easily lubricated with the lubricant used for lubricating the compression mechanism 10 inside the housing H.

In the preferred embodiment, the angular bearing 39 or the bearing 70, which rotatably supports the front end 31a of the motor shaft 31, may be eliminated.

In the preferred embodiment, the front end 31a of the motor shaft 31 is formed cylindrical and provided with the inner circumferential surface 31b for surrounding the outer circumferential surface 16c of the rear end 16b of the rotary shaft 16. Instead, the rear end 16b of the rotary shaft 16 may be formed cylindrical and provided with an inner circumferential surface for surrounding the outer circumferential surface of the front end 31a of the motor shaft 31. In this case, the second one-way clutch 33 is located in a space between the inner circumferential surface of the rear end 16b of the rotary shaft 16 and the outer circumferential surface of the motor shaft 31.

The rotary shaft 16 and the motor shaft 31 may be arranged such that the rear end of the rotary shaft 16 faces the front end of the motor shaft 31, and a one-way clutch may be located between the opposing end surfaces. In this case, with regard to one direction of rotation, the one-way clutch permits power transmission from the motor shaft 31 to the rotary shaft 16 and prevents power from being transmitted from the rotary shaft 16 to the motor shaft 31.

The second one-way clutch 33 need not be located in the refrigerant passage, which connects the crank chamber 15 to the suction chamber 40.

In the preferred embodiment, the rear sealing member 52 seals the space between the outer circumferential surface 31d of the motor shaft 31 and the housing H. Instead, the rear sealing member 52 may be arranged to seal the space between the outer circumferential surface of the rotary shaft 16 and the housing H. In this case, an outlet of the axial passage 55 is formed in the circumferential surface of the rotary shaft 16 in front of the sealing member 52.

In the preferred embodiment, the partition, which defines the suction chamber 40 and the rear lubrication chamber 53, may be eliminated. In this case, the suction chamber 40 is used as the rear lubrication chamber 53. In other words, the rear lubrication chamber 53 is used as the suction chamber 40.

In the preferred embodiment, the inlet 55a of the axial passage 55 is open inside the front lubrication chamber 51. However, the inlet 55a may be open to the crank chamber 15.

In the preferred embodiment, the compressor CP is a variable displacement type compressor. However, the invention may be applied to a fixed displacement compressor.

Instead of the piston type compression mechanism 10, a vane type compression mechanism or a scroll type compression mechanism may be employed.

The present examples and embodiments are to be considered as illustrative and not restrictive and the invention is not to be limited to the details given herein, but may be modified within the scope and equivalence of the appended claims.

1. A hybrid compressor provided with a compression mechanism, which has a rotary shaft, and an electric motor, which has a rotor, wherein the rotary shaft of the compression mechanism has a first end and a second end, wherein the first end of the rotary shaft is coupled to a rotating body for receiving power from an external drive source, and wherein the second end of the rotary shaft is coupled to the electric motor for receiving power from the electric motor, the hybrid compressor comprising:
a motor shaft located in the electric motor, wherein the motor shaft supports the rotor, and wherein the motor shaft is separate from the rotary shaft; and
a one-way clutch located between the second end of the rotary shaft and the motor shaft, wherein the one-way clutch couples the rotary shaft to the motor shaft, wherein the one-way clutch is capable of preventing power from being transmitted from the rotary shaft to the rotor, and wherein the one-way clutch is used as a coupling between the rotary shaft and the motor shaft.

2. The hybrid compressor according to claim 1, wherein the motor shaft has an end that includes a cylindrical inner circumferential surface, and the second end of the rotary shaft has an outer circumferential surface, wherein the inner circumferential surface of the end of the motor shaft surrounds the outer circumferential surface of the second end of the rotary shaft, and wherein the one-way clutch is located in a space between the outer circumferential surface and the inner circumferential surface.

3. The hybrid compressor according to claim 1, further comprising a housing for accommodating the compression mechanism, wherein the housing accommodates a sealing member that seals the motor shaft and permits the one-way clutch to be located in the housing.

4. The hybrid compressor according to claim 3, wherein the compression mechanism is a piston type compression mechanism, the compression mechanism including;
a piston;
a suction chamber;
a compression chamber;
a discharge chamber;
a crank chamber;
a crank portion accommodated in the crank chamber; and
a refrigerant passage, which connects the crank chamber to the suction chamber,
wherein the crank portion converts rotation of the rotary shaft to reciprocation of the piston,
wherein the compression mechanism discharges refrigerant gas that is drawn into the compression chamber from the suction chamber and compressed in accordance with reciprocation of the piston, and
wherein the one-way clutch is located in the refrigerant passage.

5. The hybrid compressor according to claim 4, wherein the refrigerant passage includes an axial passage, which is formed along the axial direction in the rotary shaft.

6. The hybrid compressor according to claim 3, further comprising a bearing that rotatably supports the motor shaft, wherein the bearing is located inward of the sealing member in the housing.

7. The hybrid compressor according to claim 1, wherein the electric motor includes a stator and a motor housing, wherein the motor housing rotatably supports the motor shaft and accommodates the stator and the rotor, and wherein the electric motor is formed as a unit.

8. The hybrid compressor according to claim 1, wherein the one-way clutch comprises: a plurality of recesses formed in the motor shaft about an axis of the motor shaft; a plurality of rollers, wherein each roller is accommodated in one of the recesses, and each roller is movable between an engaged position where the roller is engaged with the inner surface of the corresponding recess and the rotary shaft, and a disengaged position where the roller is apart from the engaged position; and a plurality of springs, wherein each spring urges the corresponding roller towards the engaged position, and wherein, when each roller is at the engaged position, the rotary shaft and the motor shaft are rotated in the same direction.

9. The hybrid compressor according to claim 5, further comprising a hollow restrictor, which is attached to the rotary shaft to restrict movement of the rotary shaft, wherein the restrictor is shaped like a funnel and has a small diameter portion, and wherein the small diameter portion is fitted and secured to the rotary shaft.

10. The hybrid compressor according to claim 9, wherein a space is defined between the restrictor and the rotary shaft, and wherein the space is connected to the axial passage.

11. A method for assembling a hybrid compressor, wherein a rotary shaft of a compression mechanism has a first end, which is coupled to a rotating body for receiving power from an external drive source, and a second end, which is coupled to an electric motor for receiving power from the electric motor, the method comprising:
assembling a motor shaft to which a rotor and a one-way clutch are mounted in advance to the rotary shaft along the axial direction, wherein, in the same process as assembling the motor, the motor shaft is coupled to the rotary shaft using the one-way clutch as a coupling.
